(19) United States
(12) Patent Application Publication
(10) Pub. No.: US 2017/0060996 A1
(43) Pub. Date: Mar. 2, 2017

(54) Automatic Document Sentiment Analysis

(71) Applicant: Subrata Das, Belmont, MA (US)

(72) Inventor: Subrata Das, Belmont, MA (US)

(21) Appl. No.: 15/247,318

(22) Filed: Aug. 25, 2016

Related U.S. Application Data
(60) Provisional application No. 62/210,410, filed on Aug. 26, 2015.

(51) Int. Cl. G06F 17/30; G06F 17/27

(52) U.S. Cl. CPC G06F 17/30684; G06F 17/30011; G06F 17/2705

(57) ABSTRACT

A system and method for sentiment analysis of any size of homogenous textual documents, including receiving at least one document, and parsing the at least one document to obtain n-grams of selected words and phrases. The n-grams are matched, and sentiment is determined based on the matched n-grams by weighted counting of words representing positive and negative sentiments. At least one output representative of the sentiment analysis is then generated.

### CROSS-REFERENCE TO RELATED APPLICATION

This application claims priority to U.S. Provisional Application No. 62/210,410 filed on 26 Aug. 2015. The entire contents of the above-mentioned application is incorporated herein by reference.

### FIELD OF THE INVENTION

The present invention relates to sentiment analysis of at least one document.

### BACKGROUND OF THE INVENTION

The prevalence of eCommerce coupled with human propensity to make decisions based on personal recommendation has given rise to a vast quantity of ever growing product review data. The term anonymous review is utilized herein to refer to a product review or recommendation by someone not known directly to the consumer. One early recommendation system is described in U.S. Pat. No. 4,870,579 by John Hey.

The process of evaluating anonymous recommendations or product reviews differs somewhat from that of solicited recommendations from acquaintances. Indeed, the sheer number of anonymous reviews may paralyze the consumer. Additionally, the consumer may consider factors such as age of the review and overall sentiment score, subjectively assigned by the reviewer and popularly depicted as a score out of 4 or 5 stars. The consumer task of evaluating anonymous reviews is further compounded by the existence of false positive and false negative reviews. The consumer's best defense against skewed anonymous reviews is to consider a large quantity of them. This may require a time commitment greater than is warranted or greater than the consumer is willing to make.

There is a need for automatic single document and multiple document sentiment analysis for sentiment analysis of bodies any size of homogenous textual documents.

### BRIEF SUMMARY OF THE INVENTION

An object of the present invention is to provide an automatic single document and multiple document sentiment analysis for sentiment analysis of bodies any size of homogenous textual documents.

Another object is to provide an Automatic Single Document And Multiple Document Sentiment Analysis that can easily develop unigram, bigram and n-gram frequencies. The term “n-gram” is utilized in its common meaning of a contiguous sequence of n items collected from a selected sequence of text.

Yet another object is to provide an Automatic Single Document And Multiple Document Sentiment Analysis that can generate graphic representations individual document sentiment based on language and context within the document.

A still further object is to provide an Automatic Single Document And Multiple Document Sentiment Analysis that the algorithm can generate graphic representation and score of overall sentiment for any number of documents.

Another object is to provide an Automatic Single Document And Multiple Document Sentiment Analysis that can generate sentiment for n-gram terms within a set of documents based on the context in which they appear.

Another object is to generate sentiment trend based on a number of documents collected over a period of time and then superimposed with time-series data on relevant variables.

This invention features a system and method for sentiment analysis of any size of homogenous textual documents, including receiving at least one document, and parsing the at least one document to obtain n-grams of selected words and phrases. The n-grams are matched, and sentiment is determined based on the matched n-grams by weighted counting of words representing positive and negative sentiments. At least one output representative of the sentiment analysis is then generated.

Other objects and advantages of the present invention will become obvious to the reader and it is intended that these objects and advantages are within the scope of the present invention. To the accomplishment of the above and related objects, this invention may be embodied in the form illustrated in the accompanying drawings, attention being called to the fact, however, that the drawings are illustrative only, and that changes may be made in the specific construction illustrated and described within the scope of this application.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is schematic block diagram of a system according to this invention;

FIG. 2 is a flowchart depicting a typical operation of the system by a user;

FIG. 3 is a screen shot of a Representative document that has been scored highly positive by an algorithm according to the present invention;

FIG. 4 is a screen shot of a Representative document that has been scored highly negative by the algorithm;

FIG. 5 is a screen shot with a Graphic showing overall sentiment for a sample of 100; documents reviewing a single product;

FIG. 6 is a screen shot displaying highlighted documents where a user chosen term can be found;

FIG. 7 is a screen shot with a Graphic displaying bigram frequency analysis and contextual sentiment; and

FIG. 8 is a screen shot with a graphic display of sentiment trend of a company during a period superimposed with the time-series of the company's stock values during the same period.

### DETAILED DESCRIPTION OF THE INVENTION

### A. Overview

Turning now descriptively to the drawings, in which similar reference characters denote similar elements throughout the several views, the figures illustrate a system and method for sentiment analysis of any size of homogenous textual documents. In one construction, at least one document is received and then parsed to obtain n-grams of selected words and phrases. The n-grams are matched, and sentiment is determined based on the matched n-grams by weighted counting of words representing positive and negative sentiments. At least one output representative of the sentiment analysis is then generated.

### B. Java Programming Language

Java is a general purpose programming language generally considered to be platform independent, which theoretically allows application written in Java to be run from any computing platform.

### C. Open-NLP

Open-NLP is an open source machine learning based toolkit developed and maintained by The Apache Software Foundation. According the documentation found at their website, Open-NLP supports the most common NLP tasks, such as tokenization, sentence segmentation, part-of-speech tagging, named entity extraction, chunking, parsing, and co-reference resolution. These tasks are usually required to build more advanced text processing services. Open-NLP also includes maximum entropy and perceptron based machine learning. Our implementation is used in conjunction with a lexicon to resolve extracted entities into positive and negative contexts.

Open-NLP is an open source machine learning based toolkit developed and maintained by The Apache Software Foundation. According the documentation found at their website, Open-NLP supports the most common NLP tasks, such as tokenization, sentence segmentation, part-of-speech tagging, named entity extraction, chunking, parsing, and co-reference resolution. These tasks are usually required to build more advanced text processing services. Open-NLP also includes maximum entropy and perceptron based machine learning. Our implementation is used in conjunction with a lexicon to resolve extracted entities into positive and negative contexts.

### D. Lexicon

An inventory of stemmed words with accompanying positive or negative score.

### E. Connections of Main Elements and Sub-Elements of Invention

In one construction according to the present invention, a database of two sets of words representing positive and negative sentiment, respectively, is utilized to determine the sentiment score of an individual document or a corpus of documents. For example, words or phrases like “excellent”, “beautiful”, and “worth” represent positive sentiment whereas “expensive”, “ugly”, “not worth”, and “uncomfortable” represent negative sentiment. The words in both the database and the given documents are first tokenized using Open-NLP and then stemmed using an open source implementation of Porter stemmer. The tokenized and stemmed words in a document are then matched against the tokenized and stemmed words in the database. The sentiment score is then determined based on the number of matching. The overall sentiment score of a corpus is computed by averaging all the scores from individual documents. A heat map representing positive and negative sentiment scores of individual words are determined based on the sentiment scores of the documents where the words occur. Components of this system interact programmatically, primarily facilitated via Java code interaction with application programming interfaces and database connectivity.

### F. Operation of Preferred Embodiment

Contextual Syntactic Sentiment Analysis Algorithm is an autonomous component of an integrated suite of text analysis tools known by the trade name aText, developed by Machine Analytics, Inc. of Cambridge, Mass. The contextual sentiment engine can ingest a corpus of any number of homogenous textual documents, for example the entire set of reviews for a particular product. Documents can be ingested from a variety of sources including relational databases, word processing software, plain text and HTML or XML documents.

The algorithm can automatically receive and process an individual document, and deliver a semantic sentiment score presented as proportion positive and negative. It can also process any number of homogenous documents to deliver an overall sentiment score of all documents, again presented as proportion positive and negative. Further, the algorithm develops stemmed word frequencies which themselves are scored for sentiment based on the context in which they appear in individual documents.

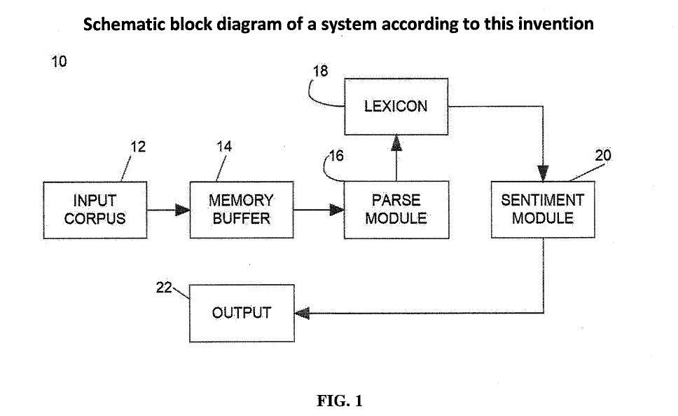

FIG. 1 depicts system 10 as a general implementation of one construction of a system according to this invention. A corpus of documents from any one of any number of sources including the sources mentioned above is ingested at input mechanism 12 such as a download module, a keyboard or a scanner, and is read into a memory 14. Documents are parsed at parse module 16 and the resulting n-grams are matched at lexicon module 18 and passed to sentiment module 20 for determination of sentiment. The sentiment determined results are output at output 22 in various formats according to runtime selections made by the user.

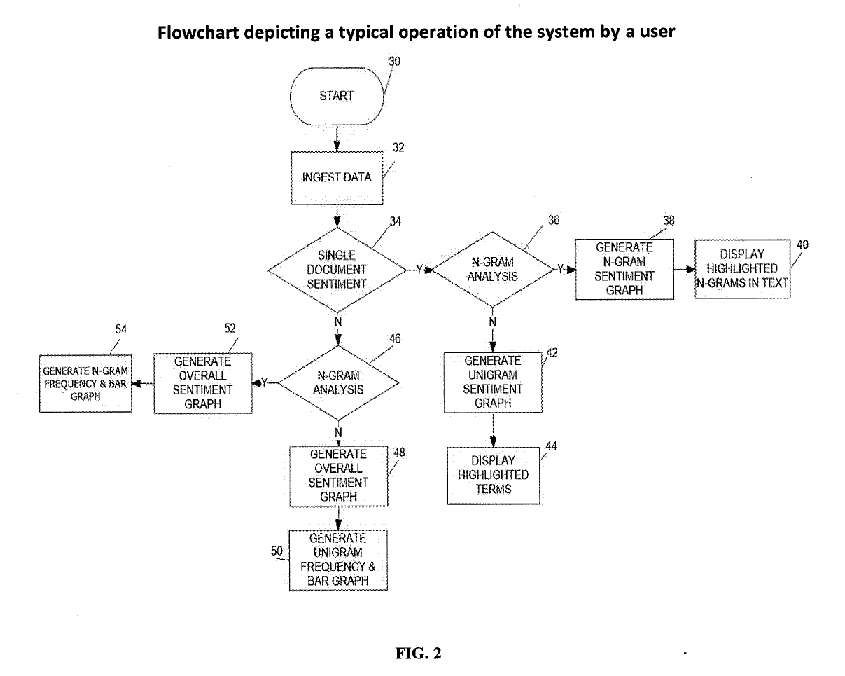

A typical interface with a user and system 10 is illustrated as a flowchart in FIG. 2. The user launches aText, step 30, and selects “sentiment analysis” at step 32. The user then selects whether to analyze a single document, which leads to step 36, or the entire corpus for sentiment which least to step 34. If single document analysis is selected, the user then selects unigram or n-gram sentiment at 46 as described below. If unigram analysis is selected at step 36, the user is presented with a graph of overall document sentiment at step 38 and the original text with positive, negative and ambiguous grams highlighted using a green/red/yellow text highlighting scheme in one construction; in the greyscale drawings submitted with the instant application, highlighted terms and bars for certain Figures are annotated separately within those Figures for a better clarity. If n-gram analysis is selected at step 36, then the user is presented with similar graphical output at step 42 albeit with combinations of words highlighted at step 44.

When the user instead chooses to analyze the entire corpus of documents at step 34, the procedure is similar in that they then choose unigram or n-gram analysis at step 46. When unigram analysis is selected they are presented with a graph of overall sentiment for all documents at step 48 and a single word frequency in descending order of frequency at step 50. In one construction, the word frequency at step 50 is also accompanied by a red and green bi-colored bar and proportion of positive and negative contexts in which the word appears. If n-gram analysis is selected at step 46 the user is able to choose word combinations of two or more words together and then is presented with output similar to the unigram analysis at steps 52 and 54 with n-gram frequencies displayed instead of unigrams.

This functionality will be more specifically described with an example. In this example, the consumer is interested in purchasing a television initially selected for its perceived value relative to its cost. The consumer would like confirm this value perception by examining anonymous reviews of the product. This particular product has hundreds of reviews which the consumer is left to evaluate on their own, a task that may require a significant time commitment.

Alternatively, the entire body of reviews can be ingested and processed by the contextual sentiment engine in just a few seconds. Once the corpus has been ingested and processed the consumer can choose to view each individual document by “clicking” on its title in the user interface. With an individual document selected the user is presented with the full text of the document where positive and negative terms are highlighted using a traffic light pattern where red, yellow and green denote negative, ambiguous and positive terms respectively. A graphic that scores sentiment for the document is also presented as a green and red bar graph depicting proportion positive and negative. This graphic is intuitively recognized by the consumer such that in the time it takes to click on a document title the consumer understands the sentiment of the review almost immediately. For example, a document with a positive score in the around of 0.40 positive is easily recognized as a somewhat negative review. Proportions around 0.50 positive would be seen as mixed, while higher proportions of positive with be seen as more positive. In this way the user is able to ascertain the content of the document without actually reading it.

More powerfully, the user can view a report of overall sentiment of all the reviews instantly via a similar red and green bar graph that also displays proportions negative and positive. The same intuitive take-aways discussed above are possible by reading this graph. This allows the consumer to quickly distill hundreds or thousands of documents into a single sentiment score within a few seconds.

In addition to calculating a sentiment score, the algorithm also calculates single term and bigram or n-gram frequencies which are presented to the user as discussed above. Frequencies are determined by stemming the language in each document so that various forms of the same word are consolidated into a single frequency. This allows the consumer to which terms were viewed positively and negatively within the body of anonymous reviews. For example, one of the terms in reviews on a television may be warranty, a term that by itself is generally neutral. However, the algorithm in addition to calculating the frequency of the word also calculates a sentiment score for each term based on the context in which it appears. So if the user is presented with the word warranty and the superimposed sentiment score is 0.30 positive it can be concluded that warranty is viewed negatively by the reviewers.

A pseudocode representation of the sentiment algorithm is presented below:

INPUT: 1) A corpus of homogeneous textual documents (e.g. A set of reviews on a particular product).

OUTPUT:

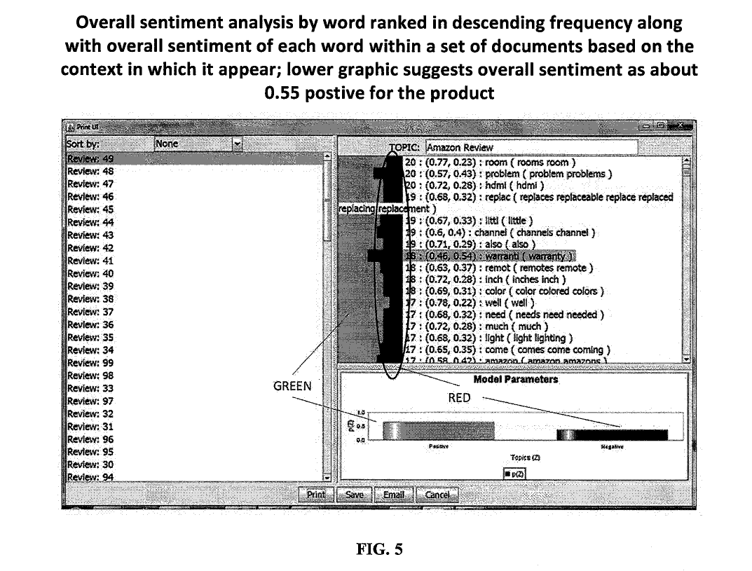

1) An overall measure of sentiment of each individual word and phrase by taking into account the contexts where it is mentioned. For example, if the word “warranty” mentioned is about 55% in the negative context (see FIG. 5) of all the reviews on a particular . television product, implying consumer unhappiness about warranty.

2) An overall measure of sentiment of each document and of the whole corpus.

STEP 1: Parse each document to individual words and phrases of interest, discarding preposition, articles, etc. Apply shallow linguistics processing to recognize negative qualifiers such as “not good” and “did not work”.

STEP 2: Compute lexicon-based sentiment measure of each document, that is, by an weighted counting of words representing positive and negative sentiments that occur in a pre-defined set of lexicons.

STEP 3: For each word, aggregate the sentiment measures collected from all the documents wherever the word occurs.

STEP 4: Provide a visualization capability to end-users highlighting all the articles where they occur and, for each highlighted articles, when selected, highlight specific sentences where the word occurs.

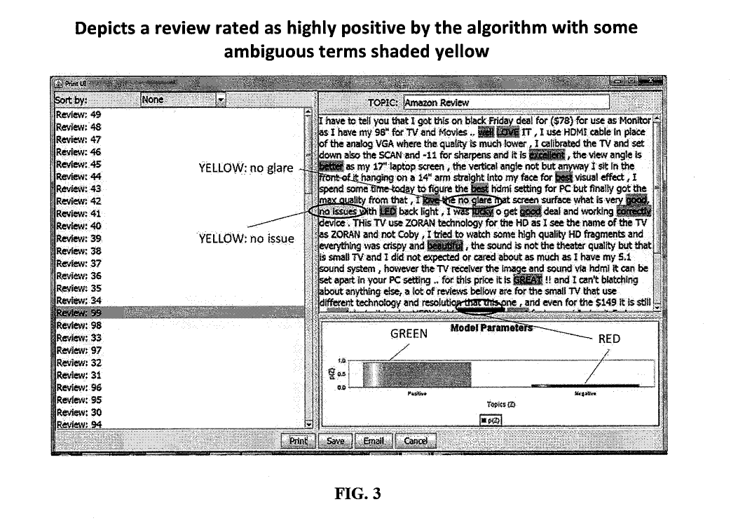

To further illustrate the algorithm, consider that a corpus of 100 actual product reviews for a television from a popular online retailer have been ingested. The subjective star based sentiment score for the product is 3.5 stars out of 5, suggesting that the consumer should expect a somewhat average product. FIG. 3 illustrates a review that the algorithm has scored as highly positive. Terms used to calculate the score are highlighted in either red for negative, green for positive or yellow for ambiguous. In once construction illustrated schematically in FIG. 3, nearly all of the terms used in the score are highlighted in green such as “well”, “love” “excellent”, “better”, “beautiful”, “GREAT” and “best”. We can also see some terms “no glare” and “no issues” highlighted in yellow to give us some idea of what an ambiguous term looks like. Below the text, the field “Model Parameters” shows nearly a full green bar on the left and a thin red bar on the right. Manually reading the review leads to the same conclusion; the review is highly positive.

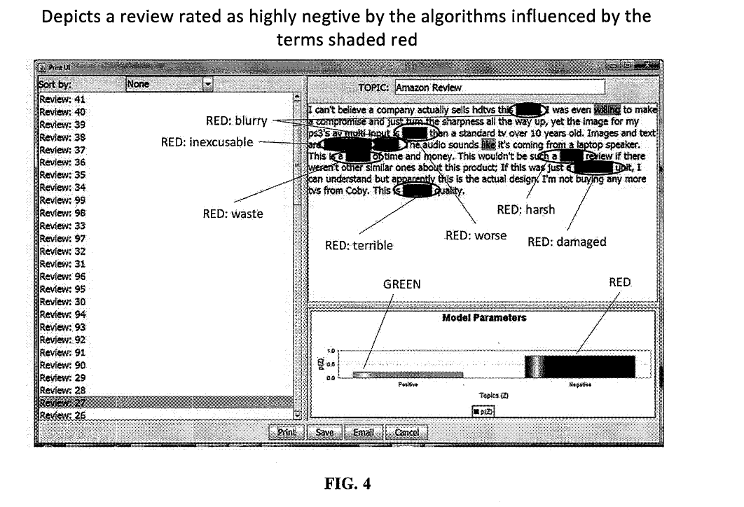

FIG. 4 is an example of a review document that has been scored highly negative by the algorithm, with most terms involved in the score highlighted in red including “blurry”, “worse”, “inexcusably”, “harsh”, “terrible” and “waste”. Below the text, the field “Model Parameters” shows nearly a full red bar on the right and a thin green bar on the left. Again manually reading the review leads the reader to the conclusion that the review is negative.

FIG. 5 demonstrates the overall sentiment functionality of the algorithm. Here it is used to process overall sentiment based on single word frequencies. We can see sentiment within which individual terms appear, with the most frequently appearing terms appearing in descending order, along with a corresponding contextual sentiment score. The lower graphic “Model Parameters” displays overall sentiment score for all of the documents. In this example it is 0.55 positive or slightly more positive than negative, with the left-hand green bar higher than the right-hand red bar. This corresponds nicely with the 3.5 star rating the product received in reviews. The term “warranty” appears to be appearing in a negative context majority of the time (0.54), indicating a warning to the manufacturer.

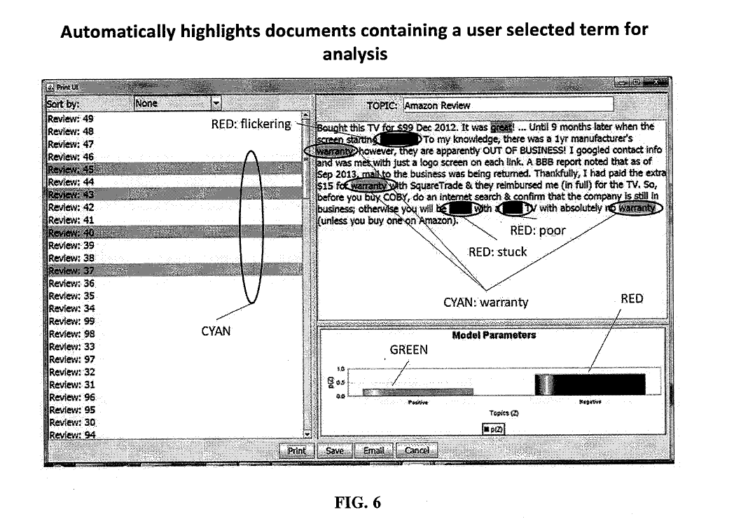

FIG. 6 is an example of extended functionality in which one of the terms appearing in the overall sentiment analysis was selected, and documents where the term appear are found and highlighted. This allows the user to examine specific terms quickly and easily. In the example warranty was chosen since it is a well understood term, which on its own is neither negative or positive. The term was shown selected in FIG. 5, and close examination reveals that it appeared somewhat more frequently in negative context than positive. One positive term highlighted in green in FIG. 6 is “great” while negative terms highlighted in red include “flickering”, “stuck” and “poor”. Below the text, the field “Model Parameters” shows nearly a small green bar on the left and a high red bar on the right.

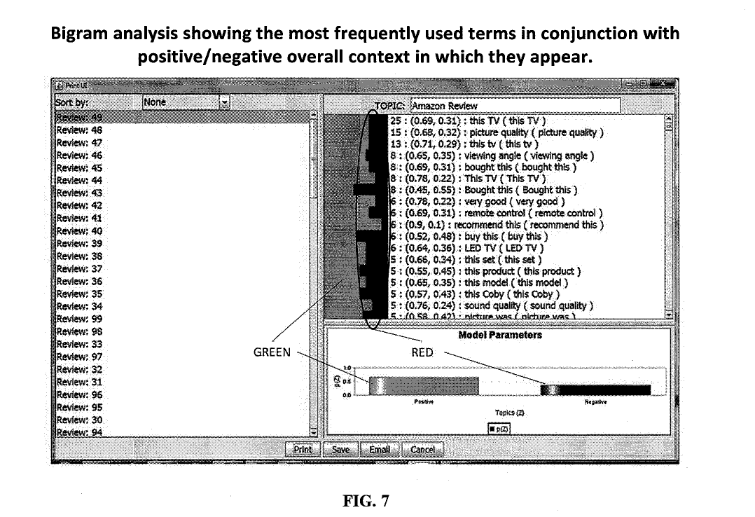

FIG. 7 is an example of overall bigram frequency analysis. It can be seen that the top two terms, two derivations of “this TV” and “picture quality” far out number any other bigram and are highly relevant to this product. The overall sentiment for these terms ranging 0.68-0.71 correspond almost exactly to 0.70, or 3.5/5 stars. Below the text, the field “Model Parameters” shows nearly a substantial green bar on the left and a much shorter red bar on the right.

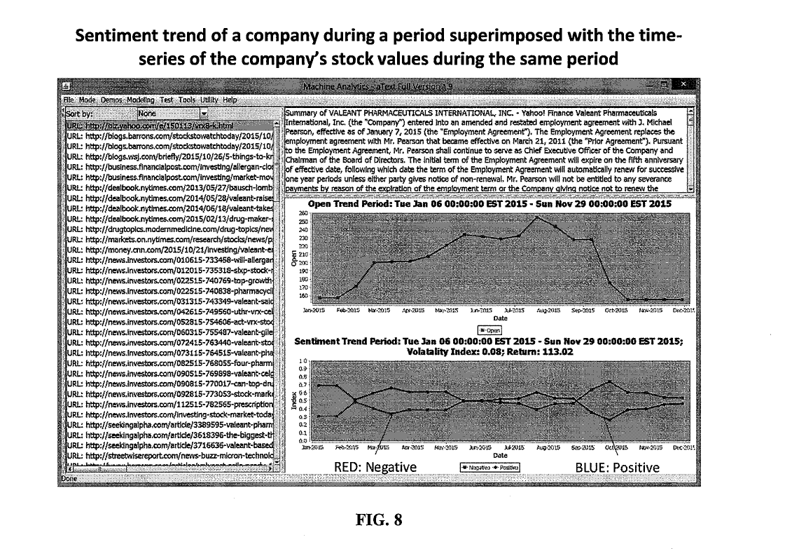

FIG. 8 is a screen shot with a graphic display of trend of financial market sentiment of the company Valeant based on analysts' articles published during 2015. The trend is superimposed with a time-series representing the stock values of Valeant during the same period. This kind of analysis allows analysts to invest by taking into account investors' sentiment. The figure clearly shows the rising negative sentiment correlates to impending fall in stockprice.

What has been described and illustrated herein is a preferred embodiment of the invention along with some of its variations. The terms, descriptions and figures used herein are set forth by way of illustration only and are not meant as limitations. Those skilled in the art will recognize that many variations are possible within the spirit and scope of the invention in which all terms are meant in their broadest, reasonable sense unless otherwise indicated. Any headings utilized within the description are for convenience only and have no legal or limiting effect.

Although specific features of the present invention are shown in some drawings and not in others, this is for convenience only, as each feature may be combined with any or all of the other features in accordance with the invention. While there have been shown, described, and pointed out fundamental novel features of the invention as applied to one or more preferred embodiments thereof, it will be understood that various omissions, substitutions, and changes in the form and details of the devices illustrated, and in their operation, may be made by those skilled in the art without departing from the spirit and scope of the invention. For example, it is expressly intended that all combinations of those elements and/or steps that perform substantially the same function, in substantially the same way, to achieve the same results be within the scope of the invention. Substitutions of elements from one described embodiment to another are also fully intended and contemplated. It is also to be understood that the drawings are not necessarily drawn to scale, but that they are merely conceptual in nature.

What is claimed is:

1. A method for analyzing at least one document via sentiment analysis comprising:
receiving at least one document;
parsing the at least one document to obtain n-grams of selected words and phrases;
matching the n-grams;
determining sentiment based on the matched n-grams by weighted counting of words representing positive and negative sentiments; and
generating an output representative of the sentiment analysis.

2. The method of claim 1 wherein receiving includes obtaining a corpus of documents from a number of sources.

3. The method of claim 1 wherein parsing includes applying linguistics processing to recognize negative qualifiers.

4. The method of claim 1 wherein the output includes a visually perceptible graph indicating positive and negative summaries of the sentiment analysis.

5. The method of claim 1 wherein the output includes highlighting specific sentences where selected words and phrases appear.

6. The method of claim 1 wherein determining sentiment includes generating sentiment for n-gram terms within a set of documents based on the context in which the n-gram terms appear.

7. The method of claim 1 wherein determining sentiment includes generating sentiment trend over a period of time and superimposing with time-series of relevant variables.
